(19) United States
(12) Patent Application Publication
(10) Pub. No.: US 2026/0290023 A1
(43) Pub. Date: Sep. 24, 2026

(54) RISK ESTIMATION DEVICE, RISK ESTIMATION METHOD, AND STORAGE MEDIUM

(71) Applicant: NEC Corporation, Tokyo (JP)

(72) Inventors: Kyota HIGA, Tokyo (JP); Masahiro YAMAGUCHI, Tokyo (JP)

(73) Assignee: NEC Corporation, Tokyo (JP)

(21) Appl. No.: 19/477,575

(22) PCT Filed: May 31, 2023
(86) PCT No.: PCT/JP2023/020278

§ 371 Date: Oct. 22, 2025

(51) Int. Cl. G06V 20/52

(52) U.S. Cl. CPC G06V 20/52

(57) ABSTRACT

A risk estimation device 1X mainly includes an inter-object relationship estimation means 15X, an inter-element relationship estimation means 16X, and a risk estimation means 17X. The inter-object relationship estimation means 15X is configured to estimate a relationship between objects detected based on observation data. The inter-element relationship estimation means 16X is configured to estimate a relationship between elements in a case where the relationship between the objects and the objects having the relationship are used as the elements. The risk estimation means 17X is configured to estimate, based on the elements and the relationship between the elements, a risk in a space observed based on the observation data.

### TECHNICAL FIELD

The present disclosure relates to a technical field of a risk estimation device, a risk estimation method, and a storage medium for estimating a risk in a monitored space.

### BACKGROUND

A system that estimates a risk within a monitored area based on an image of a monitoring camera or the like is known. For example, PTL 1 discloses a system that generates a scene graph representing a relationship between a person and a physical object detected based on an image of a camera or the like, and estimates a risk within a monitored area using a co-occurrence model regarding the co-occurrence between scene graph elements and assumed risks.

### CITATION LIST

### Patent Literature

PTL 1: JP 2022-170790 A

### SUMMARY

### Problem to Be Solved

In a situation where a plurality of persons and a plurality of physical objects are present in a space observed by a camera or the like, the same expression may be used on a scene graph even though a correspondence between a person and a physical object or a positional relationship between persons is different. In such a case, it is difficult to accurately estimate a risk only from the scene graph.

In view of the issue described above, an object of the present disclosure is to provide a risk estimation device, a risk estimation method, and a storage medium capable of accurately estimating a risk within an observed space.

### Means for Solving the Problem

One mode of the risk estimation device is a risk estimation device including:
an inter-object relationship estimation means for estimating a relationship between objects detected based on observation data;
an inter-element relationship estimation means for estimating a relationship between elements in a case where the relationship between the objects and the objects having the relationship are used as the elements; and
a risk estimation means for estimating, based on the elements and the relationship between the elements, a risk in a space observed based on the observation data.

One mode of the risk estimation method is a risk estimation method including:
estimating a relationship between objects detected based on observation data;
estimating a relationship between elements in a case where the relationship between the objects and the objects having the relationship are used as the elements; and
estimating, based on the elements and the relationship between the elements, a risk in a space observed based on the observation data.

One mode of the storage medium is a storage medium storing a program executed by a computer, the program causing the computer to execute processing including:
estimating a relationship between objects detected based on observation data;
estimating a relationship between elements in a case where the relationship between the objects and the objects having the relationship are used as the elements; and
estimating, based on the elements and the relationship between the elements, a risk in a space observed based on the observation data.

### Effect

An example advantage according to the present invention is to accurately estimate a risk within an observed space.

### BRIEF DESCRIPTION OF THE DRAWINGS

FIG. 1 illustrates a schematic configuration of a risk estimation system according to a first example embodiment.

FIG. 2 illustrates an example of a hardware configuration of a risk estimation device common to each example embodiment.

FIG. 3 is an example of a functional block of a processor of a risk estimation device according to the first example embodiment.

FIG. 4 is a diagram illustrating an example of a scene graph.

FIG. 5 is a scene graph clearly illustrating a relationship between elements.

FIGS. 6A to 6C FIG. 6A illustrates a situation where a person p1 holds a chemical s1 and a chemical s2.

FIG. 6B illustrates a situation where a person p1 holds a chemical s1 and a person p2 holds a chemical s2.

FIG. 6C is a graph showing an element ea, an element eb, and an inter-element relationship between the element ea and the element eb.

FIG. 7 is a diagram illustrating an example of a co-occurrence model.

FIG. 8 is an example of a flowchart regarding processing executed by a risk estimation device according to the first example embodiment.

FIG. 9 is an example of a functional block of a processor of a risk estimation device according to a modification example.

FIG. 10 illustrates a schematic configuration of a risk estimation system according to a second example embodiment.

FIG. 11 illustrates a schematic configuration of a video monitoring system according to a third example embodiment.

FIG. 12 is a block diagram of a risk estimation device according to a fourth example embodiment.

FIG. 13 is an example of a flowchart executed by a risk estimation device according to the fourth example embodiment.

### EXAMPLE EMBODIMENT

Hereinafter, example embodiments of a risk estimation device, a risk estimation method, and a storage medium will be described with reference to the drawings.

### First Example Embodiment

### (1) System Configuration

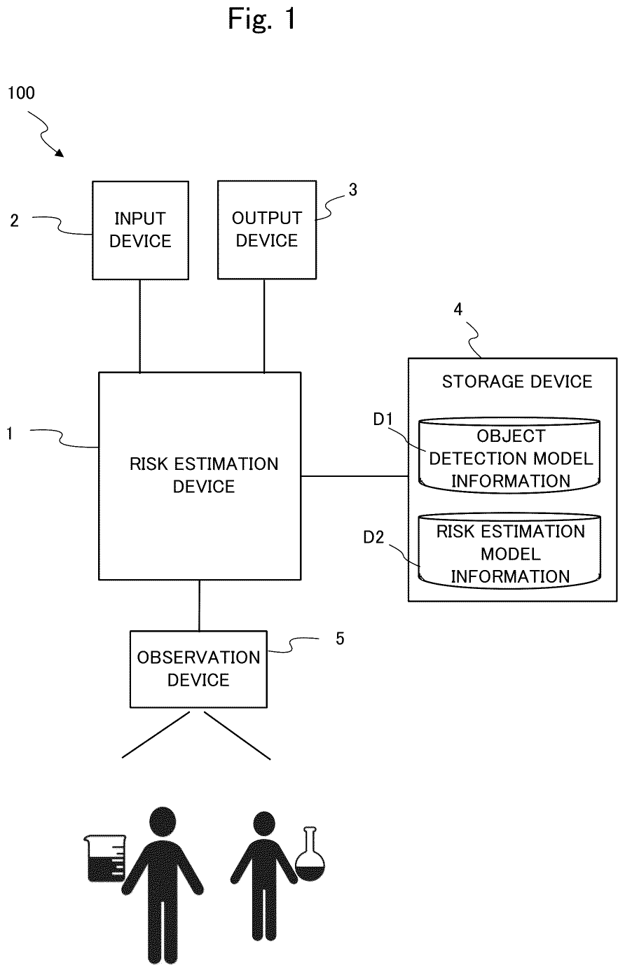

FIG. 1 illustrates a schematic configuration of a risk estimation system 100 according to a first example embodiment. The risk estimation system 100 is a system that estimates (evaluates) a risk in a space to be monitored (the space is also referred to as “monitored space”) based on information obtained by observing the monitored space, and the risk estimation system 100 mainly includes a risk estimation device 1, an input device 2, an output device 3, a storage device 4, and an observation device 5. The monitored space may be a factory, a construction site, a space inside a warehouse, a space inside a hospital, a space inside a vehicle, a space inside a station, or any other space (area) to be monitored.

The risk estimation device 1 detects an object present in the monitored space based on observation data generated by the observation device 5, and estimates a risk in the monitored space based on a relationship between the detected objects. The risk estimation device 1 outputs information regarding a result of the risk estimation. The “object” includes both a person and a physical object other than the person. The “physical object” may refer to a control panel, an arm, a pillar, a fire extinguisher, a passageway, a workstation, or any other physical object other than a person that affects a risk.

The risk estimation device 1 performs data communication with the input device 2, the output device 3, the storage device 4, and the observation device 5 via a communication network or by wireless or wired direct communication.

The input device 2 is an interface that receives input (user input) from a user who manages a risk in the monitored space. The input device 2 may be, for example, various user input interfaces such as a touch panel, a button, a keyboard, a mouse, and an audio input device. The input device 2 supplies an input signal generated based on the user input to the risk estimation device 1.

The output device 3 outputs predetermined information based on an output signal supplied from the risk estimation device 1. In this case, the output signal includes at least one of a display signal or an audio signal. The output device 3 displays information based on the display signal supplied from the risk estimation device 1, and performs audio output of the information based on the audio signal supplied from the risk estimation device 1. Examples of the output device 3 include a display device such as a display or a projector, and an audio output device such as a speaker.

The storage device 4 is a memory that stores various types of information regarding risk estimation. The storage device 4 may be an external storage device such as a hard disk connected to or incorporated in the risk estimation device 1, or may be a storage medium such as a flash memory. The storage device 4 may be a server device that performs data communication with the risk estimation device 1. The storage device 4 may include a plurality of devices.

The storage device 4 stores object detection model information D1 and risk estimation model information D2. The object detection model information D1 is information such as parameters necessary for constructing an object detection model. The object detection model is a model (engine) that outputs a detection result for an object included in observation data in a case where the observation data is input. The risk estimation model information D2 is information such as parameters necessary for constructing a risk estimation model. The risk estimation model is a model (engine) that outputs an estimation result for a risk in the monitored space in a case where data indicating a scene graph to be described later and a relationship between scene graph elements is input. The object detection model and the risk estimation model are, for example, machine learning models. Details of the object detection model information D1 and the risk estimation model information D2 will be described later.

The observation device 5 is a sensor that observes the monitored space, and includes, for example, one or a plurality of cameras (imaging means) that capture an image of the monitored space as an observation range. In addition to the camera, the observation device 5 may include an external sensor (for example, LiDAR or the like) other than the camera, a microphone (audio input device) that collects sound in the observation space, and various sensors that detect date, time, atmospheric pressure, illuminance, temperature, and the like.

The configuration of the risk estimation system 100 illustrated in FIG. 1 is an example, and various changes may be made to the configuration. For example, the risk estimation device 1 may be configured integrally with at least one of the input device 2, the output device 3, the storage device 4, or the observation device 5. In this case, the risk estimation system 100 may be implemented by one terminal device as a smartphone, a tablet terminal, or the like.

### (2) Hardware Configuration

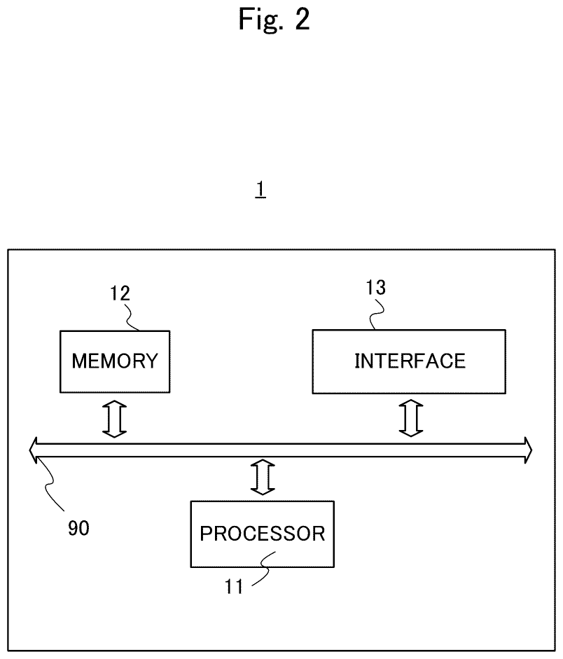

FIG. 2 illustrates a hardware configuration of the risk estimation device 1. The risk estimation device 1 includes, as hardware, a processor 11, a memory 12, and an interface 13. The processor 11, the memory 12, and the interface 13 are connected via a data bus 90.

The processor 11 functions as a controller (arithmetic device) that controls the entire risk estimation device 1 by executing a program stored in the memory 12. The processor 11 is, for example, a processor such as a central processing unit (CPU), a graphics processing unit (GPU), or a tensor processing unit (TPU). The processor 11 may include a plurality of processors. The processor 11 is an example of a computer.

The memory 12 includes various volatile memories and nonvolatile memories, such as a random access memory (RAM), a read only memory (ROM), and a flash memory. The memory 12 stores a program for executing processing executed by the risk estimation device 1. A part of information stored in the memory 12 may be stored by one or a plurality of external storage devices capable of communicating with the risk estimation device 1, or may be stored by a storage medium detachable from the risk estimation device 1. The memory 12 may function as at least a part of the storage device 4.

The interface 13 is an interface for electrically connecting the risk estimation device 1 and another device. These interfaces may be a wireless interface such as a network adapter for wirelessly transmitting and receiving data to and from the another device, or may be a hardware interface for connecting to the another device via a cable or the like.

The hardware configuration of the risk estimation device 1 is not limited to the configuration illustrated in FIG. 2. For example, the risk estimation device 1 may include at least one of the input device 2, the output device 3, the storage device 4, or the observation device 5.

### (3) Overview of Risk Estimation

Next, risk estimation executed by the risk estimation device 1 will be described. Schematically, the risk estimation device 1 estimates a risk in the monitored space based on a scene graph representing a relationship between objects detected based on observation data output by the observation device 5 and a relationship between elements in the scene graph. Thus, the risk estimation device 1 accurately estimates the risk in the monitored space and outputs information regarding the estimation result.

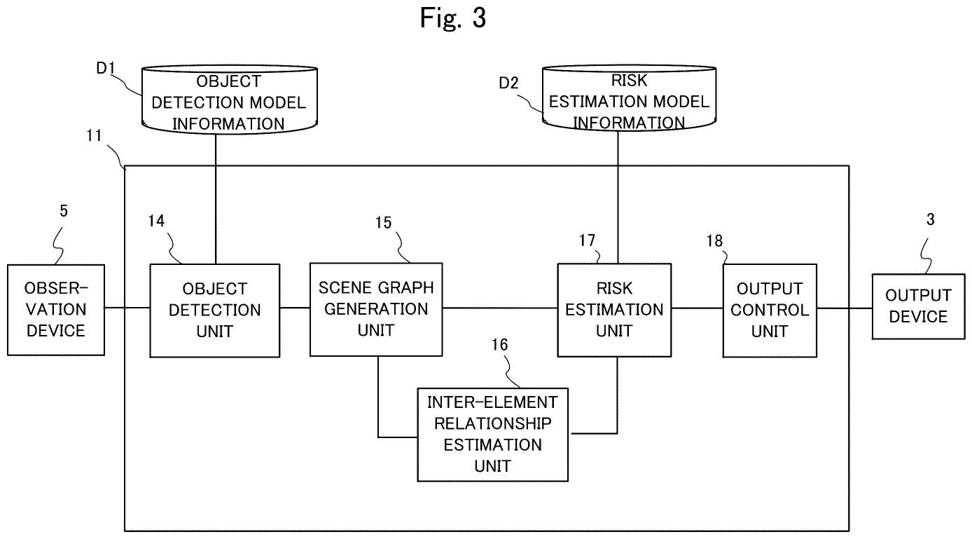

FIG. 3 is an example of a functional block of the processor 11 of the risk estimation device 1. The processor 11 of the risk estimation device 1 functionally includes an object detection unit 14, a scene graph generation unit 15, an inter-element relationship estimation unit 16, a risk estimation unit 17, and an output control unit 18. In FIG. 3, blocks between which data is exchanged are connected by a solid line, but a combination of the blocks between which the data is exchanged is not limited to the illustrated combination. The same applies to diagrams of other functional blocks to be described later.

At the timing of risk estimation, the object detection unit 14 detects an object present within the monitored space of the observation device 5 based on the observation data output by the observation device 5. In this case, the object detection unit 14 constructs an object detection model based on the object detection model information D1, and detects an object based on information output by the object detection model in a case where the observation data is input to the constructed object detection model. For example, the object detection unit 14 assigns an object ID for identifying an object and a label indicating the type of object (that is, a class into which the object is classified) to each of the detected objects.

The timing of risk estimation may be a timing at predetermined time intervals (for example, intervals based on observation data acquisition intervals), a timing at which an instruction signal to instruct execution of risk estimation is received from the input device 2 or the like, or a timing at which a risk estimation start condition stored in advance in the memory 12 or the like is satisfied. The object detection unit 14 may detect an object based on observation data obtained from the observation device 5 at the timing of risk estimation, or may detect an object based on time-series observation data obtained during a period from a predetermined time before the risk estimation timing to the risk estimation timing.

Here, the object detection model will be supplementarily described. The object detection model is, for example, a machine learning model (including a statistical model, and the same applies hereinafter) having an arbitrary architecture such as a neural network or a support vector machine. The object detection model may be a model used in segmentation such as instance segmentation. The object detection model is trained using training data, and parameters of the object detection model obtained by the training are stored in advance in the memory 12 as the object detection model information D1. The training data includes, for example, a plurality of records serving as a set of observation data compatible with an input format (predetermined tensor format) of the object detection model and ground truth data indicating a correct output to be output by the object detection model in a case where the observation data is input. In a case where the object detection model is constructed by a neural network, the object detection model information D1 includes, for example, various parameters (including hyperparameters) such as a layer structure, a neuron structure of each layer, the number of filters and a filter size in each layer, and a weight of each element of each filter.

The scene graph generation unit 15 estimates a scene graph representing a relationship between a person and a physical object detected by the object detection unit 14. The scene graph generation unit 15 estimates whether there is a relationship between the detected person and the detected physical object, and estimates a relationship between the person and the physical object, which are estimated to have a relationship. The scene graph is a graph in which a relationship between nodes is represented by a directed edge with a person as an object and a physical object as an object as nodes, and represents a set of elements with a relationship between nodes (including nodes constituting the relationship) as an element. A specific example of the scene graph will be described later. Various methods have been proposed as a method for generating a scene graph, and any method among them can be adopted. In general, the scene graph is not limited to a relationship between a person and a physical object, but also includes a relationship between physical objects.

The inter-element relationship estimation unit 16 estimates a relationship between elements (referred to as “inter-element relationship”) in the scene graph. For example, the inter-element relationship estimation unit 16 estimates the inter-element relationship between a first element and a second element for any two elements (for convenience of description, they are referred to as “first element” and “second element”), and determines a class into which the inter-element relationship between the first element and the second element is classified. The inter-element relationship estimation unit 16 regards each of all pairs of elements of the scene graph as a first element and a second element, and estimates an inter-element relationship of each pair of scene graph elements. The inter-element relationship estimation unit 16 supplies an estimation result for the inter-element relationship (for example, information indicating the classified class) to the risk estimation unit 17.

A specific example of the inter-element relationship will be described. In a first example of the inter-element relationship, the inter-element relationship is a relationship related to a distance between elements, and the inter-element relationship estimation unit 16 estimates a relationship (that is, a positional relationship) based on a distance between a person and a physical object of the first element and a person and a physical object of the second element. In this case, the inter-element relationship estimation unit 16 calculates the distance between the person and the physical object of the first element and the person and the physical object of the second element, determines that a relationship between the first element and the second element belongs to a class corresponding to “close distance” in a case where the calculated distance is equal to or more than a threshold, and determines that the relationship between the first element and the second element belongs to the class corresponding to “long distance” in a case where the calculated distance is less than the threshold. The above-described threshold is, for example, a predetermined suitability value and is stored in the memory 12 or the like. The classification of the relationship based on the distance is not limited to two classes of “close distance” and “long distance”, and may be three or more classes. In this case, for example, the inter-element relationship estimation unit 16 uses a plurality of thresholds having different values and classifies the relationship based on the distance into one of three or more classes.

Here, the “distance” may be a two-dimensional distance on an image in a case where the observation data is an image without distance information, or may be a three-dimensional distance in a real space in a case where the observation data is an image with distance information or three-dimensional point cloud data. The distance calculated by the inter-element relationship estimation unit 16 may be a distance based on a physical object, may be a distance based on a person, or may be a distance based on a person and a physical object. In this case, for example, the inter-element relationship estimation unit 16 calculates a distance between an arbitrary point on the bounding rectangle of a person and/or a physical object of the first element and an arbitrary point of the bounding rectangle of a person and/or a physical object of the second element. As a specific example of such a distance calculation method, in an example of calculating a distance based on a physical object, the inter-element relationship estimation unit 16 calculates, for example, a center-to-center distance between the bounding rectangle (bounding box) of the physical object of the first element and the bounding rectangle of the physical object of the second element in an image. In an example of calculating a distance based on a person, the inter-element relationship estimation unit 16 calculates, for example, a center-to-center distance between the bounding rectangle of the person of the first element and the bounding rectangle of the person of the second element in the image. In an example of calculating a distance based on a person and a physical object, the inter-element relationship estimation unit 16 calculates, for example, a center-to-center distance between the bounding rectangle of the person and the physical object of the first element and the bounding rectangle of the person and the physical object of the second element in the image. In a case where the three-dimensional distance in the real space is used, for example, the inter-element relationship estimation unit 16 calculates a center-to-center distance of the circumscribed rectangular parallelepiped of the person and/or the physical object instead of calculating the center-to-center distance of the bounding rectangle of the person and/or the physical object.

In a second example of the inter-element relationship, the inter-element relationship indicates whether a person is common between the elements, and the inter-element relationship estimation unit 16 estimates whether the person of the first element and the person of the second element are the same person. In this case, the inter-element relationship estimation unit 16 determines that the inter-element relationship between the first element and the second element belongs to a class corresponding to “the same person” in a case where the person of the first element and the person of the second element are common (the same), and determines that the inter-element relationship between the first element and the second element belongs to a class corresponding to “different person” in a case where the person of the first element and the person of the second element are different persons.

The first example and the second example of the inter-element relationship described above may be applied in combination. For example, in a case where the person of the first element and the person of the second element are the same, the inter-element relationship estimation unit 16 determines that the inter-element relationship between the first element and the second element belongs to a class corresponding to “the same person” based on the second example. On the other hand, in a case where the person of the first element and the person of the second element are different persons, the inter-element relationship estimation unit 16 further calculates a distance based on the first example and determines a class corresponding to the distance.

The risk estimation unit 17 estimates a risk in the monitored space based on the scene graph generated by the scene graph generation unit 15 and the estimation result for the inter-element relationship generated by the inter-element relationship estimation unit 16. In this case, the risk estimation unit 17 constructs a risk estimation model based on the risk estimation model information D2, and acquires a risk estimation result output by the risk estimation model in a case where data indicating the estimation result for the scene graph and the inter-element relationship is input to the risk estimation model.

The risk estimation model is, for example, a co-occurrence model that is a machine learning model regarding co-occurrence between a scene graph element and inter-element relationship and an assumed risk. A specific example of the co-occurrence model will be described later.

The risk estimation model is not limited to the co-occurrence model. For example, the risk estimation model may be a model that outputs a risk estimation result in a case where data in a predetermined tensor format indicating a scene graph and an inter-element relationship is input to the risk estimation model. The risk estimation result output by the risk estimation model includes, for example, the most probable risk class and the confidence level of risk occurrence The risk estimation model is, for example, a machine learning model (including a statistical model, and the same applies hereinafter) having an arbitrary architecture such as a neural network or a support vector machine, the training is performed using training data, and parameters of the risk estimation model obtained by the training are stored in advance in the memory 12 as the risk estimation model information D2. The training data includes, for example, a plurality of records serving as a set of input data and ground truth data indicating a correct output to be output by the risk estimation model in a case where the data is input. In a case where the risk estimation model is constructed by a neural network, the risk estimation model information D2 includes, for example, various parameters (including hyperparameters) such as a layer structure, a neuron structure of each layer, the number of filters and a filter size in each layer, and a weight of each element of each filter.

The output control unit 18 outputs information regarding a risk estimation result output by the risk estimation unit 17. In this case, by generating an output signal related to the risk estimation result and supplying the generated output signal to the output device 3 via the interface 13, the output control unit 18 causes the output device 3 to execute display or audio output. For example, in a case where the risk estimation unit 17 estimates the occurrence of a risk having a confidence level equal to or more than a predetermined degree, the output control unit 18 causes the output device 3 to output information indicating a warning related to the risk and/or a countermeasure for the risk As the predetermined degree, a different value may be used for each risk.

The output control unit 18 may identify the scene graph elements that contribute to the occurrence of the risk and the inter-element relationship, and cause the output device 3 to output information regarding the identified elements and the inter-element relationship. In a case where the co-occurrence model is used as the risk estimation model, the output control unit 18 may cause the output device 3 to output information regarding a relationship added through filtering by label propagation. In a case where the co-occurrence model is used as the risk estimation model, the output control unit 18 is not limited to the above-described output example, and may perform various outputs disclosed in PTL 1.

The output control unit 18 may transmit information regarding the risk estimation result (for example, a report indicating a risk) to another device that manages the risk, or may store the information in the storage device 4 or the like, instead of causing the output device 3 to perform display or audio output.

Components of the object detection unit 14, the scene graph generation unit 15, the inter-element relationship estimation unit 16, the risk estimation unit 17, and the output control unit 18, which are described in FIG. 3, can be implemented, for example, by the processor 11 executing a program. Each component may also be achieved by recording a necessary program in an optional nonvolatile storage medium and installing the program as necessary. At least a part of the components is not limited to being implemented by software through a program, and may be implemented by a combination of any of hardware, firmware, and software, or the like. At least a part of these components may be implemented using, for example, a user-programmable integrated circuit such as a field-programmable gate array (FPGA) or a microcontroller. In this case, a program including the above-described components may be implemented by using the integrated circuit. At least a part of the components may include an application specific standard product (ASSP), an application specific integrated circuit (ASIC), or a quantum processor (quantum computer control chip). In this manner, the components may be implemented by various types of hardware. The same applies to other example embodiments to be described later. These components may also be implemented by, for example, cooperation of a plurality of computers by using a cloud computing technology or the like.

### (4) Scene Graph and Inter-Element Relationship

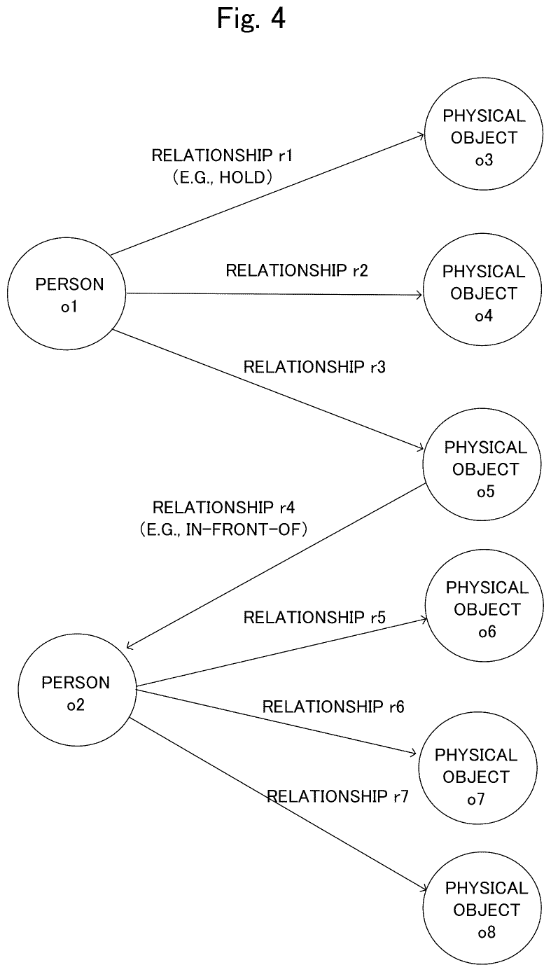

FIG. 4 is a diagram illustrating an example of a scene graph generated by the scene graph generation unit 15. In the example of FIG. 4, eight objects are detected, and relationships r1 to r7 between persons with object IDs “o1” and “o2” and physical objects with object IDs “o3” to “o8” are defined. The graph illustrated in FIG. 4 corresponds to a bipartite graph divided into a set of human nodes and a set of physical object nodes, and each relationship is represented by a directed edge. The scene graph illustrated in FIG. 4 has seven elements corresponding to the number of directed edges.

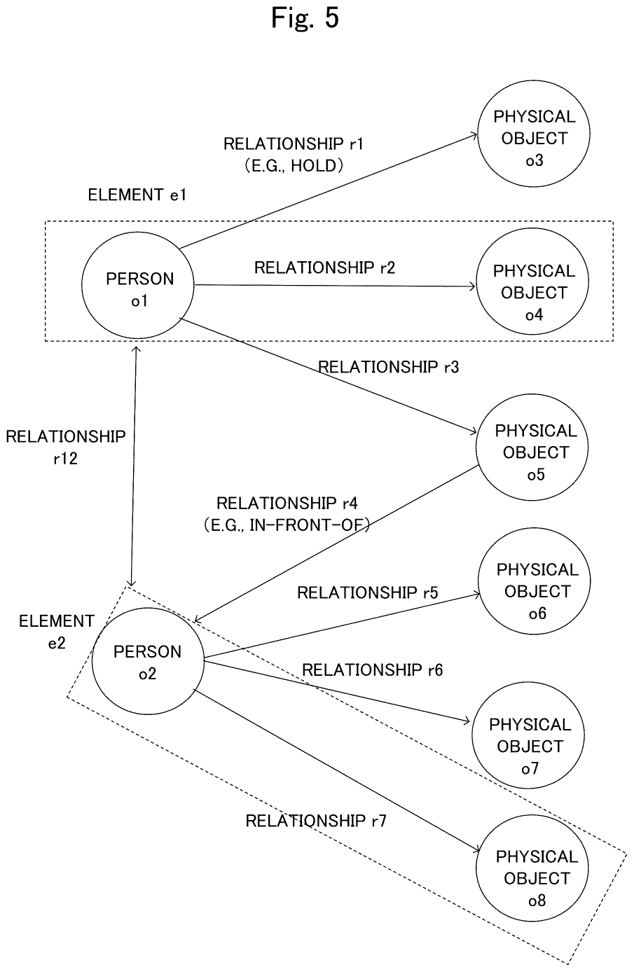

FIG. 5 is a scene graph clearly illustrating the inter-element relationship determined by the inter-element relationship estimation unit 16. In the example of FIG. 5, the inter-element relationship estimation unit 16 estimates a relationship r12 between an element e1 corresponding to the person with the object ID “o1” and the physical object with the object ID “o4” having the relationship r2 and an element e2 corresponding to the person with the object ID “o2” and the physical object with the object ID “o8” having the relationship r7. The inter-element relationship estimation unit 16 also estimates an inter-element relationship of a pair of elements other than the pair of the element e1 and the element e2.

The risk estimation unit 17 performs risk estimation in consideration of the inter-element relationship in addition to the scene graph. Thus, the risk estimation unit 17 can execute risk estimation that accurately considers a correspondence between a person and a physical object, a positional relationship between persons, and the like.

Here, the effect of risk estimation by the risk estimation unit 17 will be supplementarily described using a comparative example in which risk estimation is performed using only a scene graph as an input to a co-occurrence model. In this comparative example, there is a case where a risk is erroneously estimated without considering a positional relationship between elements.

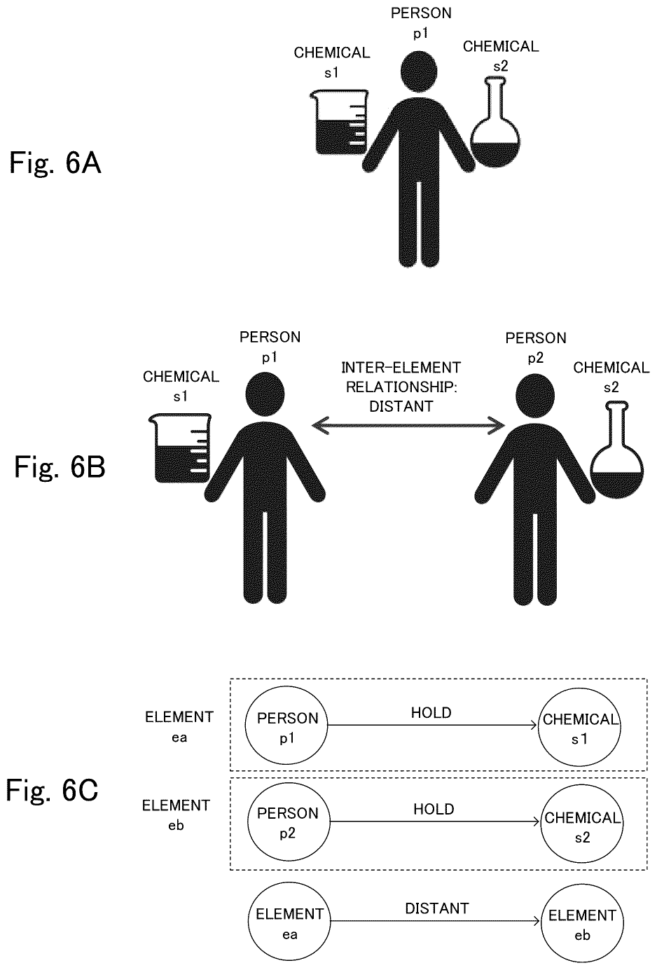

FIG. 6A illustrates a situation where a person p1 holds a chemical s1 and a chemical s2. FIG. 6B illustrates a situation where the person p1 holds the chemical s1 and a person p2 holds the chemical s2. Since the chemical s1 and the chemical s2 come into contact with each other to generate toxic gas, there is a high risk that toxic gas is generated when the person p1 simultaneously holds the chemical s1 and the chemical s2 as illustrated in FIG. 6A. On the other hand, as illustrated in FIG. 6B, in a situation where the person p1 and the person p2, who are distant from each other, respectively hold the chemical s1 and the chemical s2, the risk of generating a harmful gas is lower than that in the situation illustrated in FIG. 6A. However, since all the elements of the scene graph are input in the co-occurrence model, the inputs to the co-occurrence model are the same in the situation illustrated in FIG. 6A and the situation illustrated in FIG. 6B. Therefore, in the comparative example, the situation illustrated in FIG. 6A and the situation illustrated in FIG. 6B have the same risk estimation result, and as a result, the risk estimation accuracy decreases in the comparative example.

In consideration of the above, the risk estimation device 1 according to the present example embodiment performs risk estimation in further consideration of the inter-element relationship. For example, in the situation illustrated in FIG. 6B, the risk estimation device 1 classifies an inter-element relationship between an element ea corresponding to a relationship in which the person p1 holds the chemical s1 and an element eb corresponding to a relationship in which the person p2 holds the chemical s2 as “distant”.

FIG. 6C is a graph showing the element ea, the element eb, and the inter-element relationship between the element ea and the element eb. The element ea, the element eb, and the inter-element relationship between the element ea and the element eb correspond to information input to the risk estimation model by the risk estimation unit 17 in the situation illustrated in FIG. 6B. In the situation illustrated in FIG. 6B, the risk estimation unit 17 adds the inter-element relationship “distant” between the element ea and the element eb to the risk estimation model as input, in addition to the element ea and the element eb. Thus, the risk estimation unit 17 can perform risk estimation in accordance with the situation illustrated in FIG. 6B. In the case of the situation illustrated in FIG. 6A, for example, the inter-element relationship estimation unit 16 classifies the inter-element relationship between the element ea and the element eb as “same person”, and the risk estimation unit 17 adds the inter-element relationship “same person” to the risk estimation model as input, in addition to the element ea and the element eb. Thus, the risk estimation unit 17 can perform risk estimation in accordance with the situation illustrated in FIG. 6A.

### (5) Co-Occurrence Model

Next, a case where a co-occurrence model is used as the risk estimation model will be supplementarily described. Details of the co-occurrence model are disclosed in, for example, PTL 1.

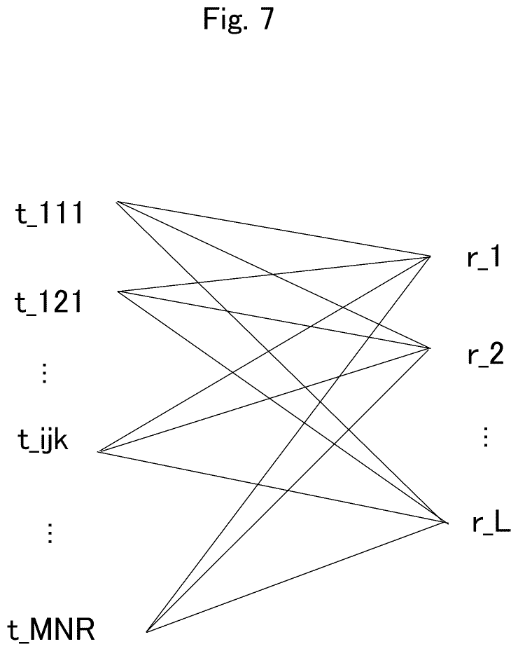

FIG. 7 is a diagram illustrating an example of the co-occurrence model. Nodes on the left side of the co-occurrence model list the combinations of the scene graph elements and the inter-element relationships, and are hereinafter also referred to as “element·inter-element relationship t_ijk”. “i” (1≤i≤M) is an index indicating a class of a physical object (also referred to as “entity class”), “j” (1≤j≤N) is an index indicating a class of a relationship between objects and an inter-element relationship (also referred to as “relationship class”), and “k” (1≤k≤R) is an index indicating a class of a person (also referred to as “entity or attribute class”). The class of a relationship between objects and an inter-element relationship included in the co-occurrence model is a relationship observed from observation data (for example, an image) used for input of the co-occurrence model in the training data used for training of the co-occurrence model. Nodes on the right side of the co-occurrence model list the classes of assumed risks. “l” (1≤l≤L) indicates an index of a class of an assumed risk, and “rl” is data regarding the risk of the index l included in the training data of the co-occurrence model. The risk rl also includes a normal state.

The co-occurrence model defines a weight coefficient “W_l[ijk]” representing a co-occurrence relationship between the element·inter-element relationship t_ijk and the risk rl by normalized pointwise mutual information. By using the normalized pointwise mutual information, a possible value of the weighting coefficient W_l[ijk] can be set in a range from −1 to 1. The co-occurrence model is trained in advance using training data, and the weight coefficient W_l[ijk] between the element·inter-element relationship t_ijk and the risk rl is determined. The training data can be prepared by generating a scene graph from the observation data and labeling the risk occurring in the space observed using the observation data by a person.

The risk estimation unit 17 performs label propagation and logistic regression. The risk estimation unit 17 performs the label propagation using the scene graph as a seed. The label propagation is one of message-passing methods. The label propagation is a semi-supervised learning method for training a model by propagating data labels to associated labels. In the label propagation, label propagation of the relationship score of the element·inter-element relationship t_ijk is performed. The relationship score is a score for the probability of the existence of the element·inter-element relationship t_ijk, and an initial value is “one” in the element·inter-element relationship t_ijk identified by the scene graph generation unit 15 and the inter-element relationship estimation unit 16, and “zero” in the element·inter-element relationship t_ijk not identified. When the label propagation of the relationship score is performed, the relationship score for the unestimated element·inter-element relationship t_ijk becomes a value larger than “zero”. By performing the label propagation, even for the element·inter-element relationship t_ijk not identified by the scene graph generation unit 15 and the inter-element relationship estimation unit 16, the existence is estimated by propagation from another element·inter-element relationship t_ijk, or conversely, even for the element·inter-element relationship t_ijk identified by the scene graph generation unit 15 and the inter-element relationship estimation unit 16, erroneous detection is estimated by propagation from another element·inter-element relationship t_ijk. By performing the label propagation in this manner, features of the scene graph (graph structure) or the like are updated.

The risk estimation unit 17 determines whether the value of the relationship score after label propagation is equal to or more than a predetermined value, and filters the element·inter-element relationship t_ijk having a relationship score equal to or more than the predetermined threshold. The risk estimation unit 17 calculates the risk score using an equation for calculating the risk score based on the filtered element·inter-element relationship t_ijk. As the equation described above, for example, Equation (6) disclosed in PTL 1 is used.

### (6) Processing Flow

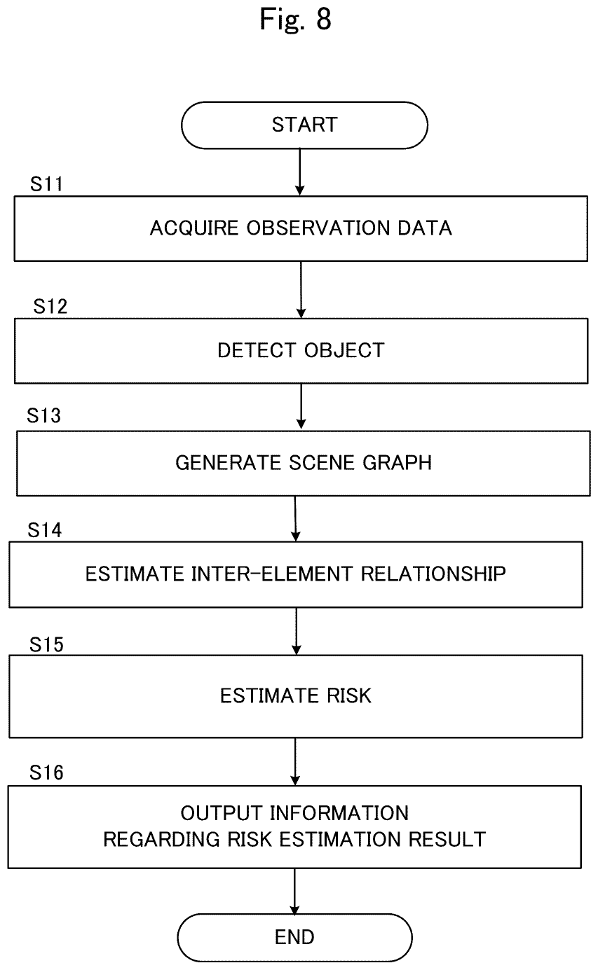

FIG. 8 is an example of a flowchart regarding processing executed by the risk estimation device 1. The risk estimation device 1 executes the flowchart illustrated in FIG. 8 at a risk estimation timing.

First, the risk estimation device 1 acquires observation data output by the observation device 5 (step S11). In this case, the risk estimation device 1 may store the observation data acquired from the observation device 5 in the storage device 4 or the memory 12, and may acquire the observation data to be used for risk estimation from the storage device 4 or the memory 12 at the risk estimation timing. The observation data to be used for the risk estimation may be the most recent observation data among the observation data generated by the observation device 5 at a predetermined cycle, or may be the most recent observation data for a predetermined time length.

Next, the risk estimation device 1 detects an object within the monitored space based on the observation data acquired in step S11 and the object detection model information D1 (step S12). The risk estimation device 1 generates a scene graph indicating a relationship between a person and a physical object included in the object detected in step S12 (step S13). The risk estimation device 1 estimates an inter-element relationship of the scene graph (step S14).

The risk estimation device 1 estimates a risk within the monitored space based on the scene graph generated in step S13, the inter-element relationship of the scene graph estimated in step S14, and the risk estimation model information D2 (step S15). The risk estimation device 1 outputs information regarding a risk estimation result estimated in step S15 (step S16). In this case, the risk estimation device 1 may cause the output device 3 to display or audibly output information regarding the risk estimation result, may transmit the information to another device, or may store the information in the storage device 4 or the memory 12.

### (6) Modification Example

Next, modification examples of the above-described example embodiments will be described. The following modification examples may be arbitrarily combined and applied to the above-described example embodiments.

### First Modification Example

The risk estimation device 1 may predict the state of the object after a lapse of a predetermined time based on the observation data, and perform risk estimation based on predicted results for the scene graph and the inter-element relationship after the lapse of a predetermined time.

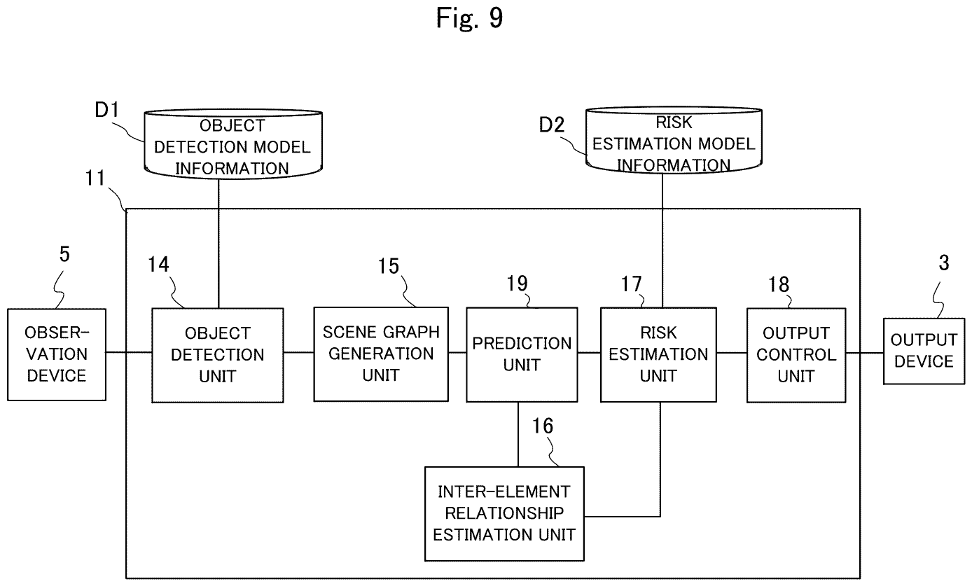

FIG. 9 is an example of a functional block of the processor 11 of the risk estimation device 1 according to the present modification example. The processor 11 of the risk estimation device 1 according to the present modification example functionally includes an object detection unit 14, a scene graph generation unit 15, an inter-element relationship estimation unit 16, a risk estimation unit 17, an output control unit 18, and a prediction unit 19. The object detection unit 14 and the scene graph generation unit 15 detect the object and generate the scene graph as described with reference to FIG. 3.

The prediction unit 19 predicts the state of each object after a lapse of a predetermined time. In this case, for example, the prediction unit 19 predicts the state of each object (including a position, a posture, and a relationship between objects) after a lapse of a predetermined time using an arbitrary prediction technique (including human behavior prediction or the like) based on time-series observation data or the like acquired by the risk estimation device 1 from the observation device 5. The prediction unit 19 updates the scene graph generated by the scene graph generation unit 15 based on the predicted state of each object after a lapse of a predetermined time, and supplies the updated scene graph to the risk estimation unit 17. The inter-element relationship estimation unit 16 estimates an inter-element relationship after a lapse of a predetermined time from the state of each object after a lapse of a predetermined time predicted by the prediction unit 19. The inter-element relationship estimation unit 16 supplies an estimation result for the inter-element relationship after a lapse of a predetermined time to the risk estimation unit 17.

The risk estimation unit 17 estimates a risk within the monitored space after a lapse of a predetermined time based on the scene graph supplied from the prediction unit 19 (that is, a scene graph reflecting the predicted state of each object after a lapse of a predetermined time) and the estimation result for the inter-element relationship after a lapse of a predetermined time supplied from the inter-element relationship estimation unit 16. In this case, the risk estimation unit 17 inputs data indicating the estimation result for the scene graph and the inter-element relationship after a lapse of a predetermined time to the risk estimation model, and acquires the risk estimation result output by the risk estimation model. The risk estimation unit 17 supplies the risk estimation result to the output control unit 18.

As described above, the risk estimation device 1 according to the present modification example can estimate a risk occurring in the monitored space after a lapse of a predetermined time.

### Second Modification Example

In a case where the observation device 5 includes an audio input device such as a microphone, the object detection unit 14 may detect an object based on audio data generated by the audio input device.

In this case, for example, the object detection unit 14 detects an audio object with a predetermined pattern from audio data acquired from the observation device 5. The audio detection result is also regarded as a kind of object. Thus, the power spectrum of ambient sound in the monitored space and the presence or absence of the collision sound can be considered in the risk estimation. The object detection unit 14 may identify a sound arrival direction based on the audio data generated by a plurality of audio input devices. Thus, it is possible to consider the arrival direction of the collision sound or the like, the sound source location, and the like in the risk estimation.

Similarly, in a case where a sensor that detects data such as date, time, temperature, pressure (atmospheric pressure), and illuminance is included in the observation device 5, the object detection unit 14 detects an object of sensor data with a predetermined pattern from the collected sensor data using a sensor pattern detection model or the like to which the data acquired by the sensor is input. Parameters of the sensor pattern detection model are stored in advance in the storage device 4, the memory 12, or the like. The object detection unit 14 may also regard the detection result of the sensor as a kind of object.

### Second Example Embodiment

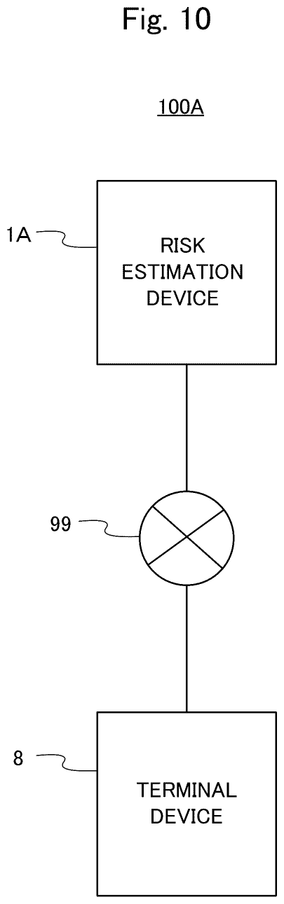

FIG. 10 illustrates a schematic configuration of a risk estimation system 100A according to a second example embodiment. The risk estimation system 100A according to the second example embodiment includes a risk estimation device 1A that functions as a server and a terminal device 8 that functions as a client. The risk estimation device 1A and the terminal device 8 perform data communication via a network 99. Hereinafter, the same components as those of the first example embodiment are appropriately denoted by the same reference signs, and the description thereof will be omitted.

The terminal device 8 is a terminal used by a user who performs risk estimation in the monitored space, has an input function, a display function, a communication function, and an observation function (such as an imaging function), and functions as the input device 2, the output device 3, the observation device 5 and the like illustrated in FIG. 1. The terminal device 8 may be, for example, a personal computer, a tablet terminal such as a smartphone, or a personal digital assistant (PDA). An observation device separate from the terminal device 8 may be provided in the risk estimation system 100A to supply observation data to the risk estimation device 1A.

The risk estimation device 1A has the same hardware configuration as the hardware configuration of the risk estimation device 1 illustrated in FIG. 2, and the processor 11 of the risk estimation device 1A has the functional blocks illustrated in FIG. 3 or 9 described in the first example embodiment. The risk estimation device 1A receives the observation data from the terminal device 8 or the observation device separate from the terminal device 8 via the network 99, and executes risk estimation processing. The risk estimation device 1A transmits an output signal for outputting information regarding a risk estimation result to the terminal device 8 via the network 99.

As described above, the risk estimation device 1A according to the second example embodiment can suitably notify the user of the terminal device 8 of the information regarding the risk estimation result in the monitored space.

### Third Example Embodiment

The third example embodiment, as an example of an application to a medical field and healthcare field, relates to a video monitoring system for ensuring the safety of people moving in a hospital which is an example of a medical workplace.

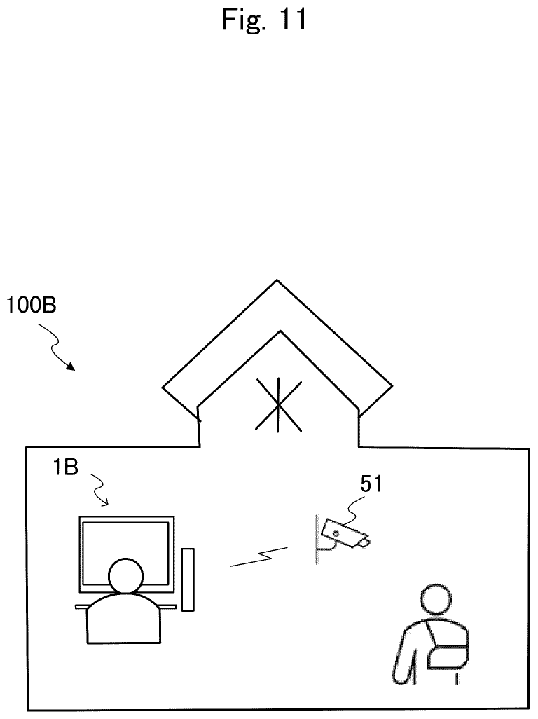

FIG. 11 illustrates a schematic configuration of a video monitoring system 100B according to the third example embodiment. The video monitoring system 100B includes a risk estimation device 1B, one or more cameras 51 provided in the hospital. Hereinafter, the same components as in the first example embodiment or the second example embodiment are denoted by the same reference numerals and their explanations will be omitted.

The camera 51 generates time series images (video data) which capture the inside of the hospital and provide the generated video data to the risk estimation device 1B. For example, the camera 51 is provided in each room, each corridor, and/or each elevator in the hospital to acquire video data which captures the inside of the hospital.

For example, the risk estimation device 1B is equipped with the hardware configuration shown in FIG. 2 and the functional block configuration shown in FIG. 3 or FIG. 9. Then, the risk estimation device 1B uses the video data acquired from the camera 51 as the observation data in the first example embodiment or the second example embodiment, and estimates risks (e.g., risky actions) regarding patients, hospital staff (including medical workers), visitors in the same way as in the first example embodiment or the second example embodiment. In this case, the risk estimation device 1B may perform the risk estimation based on the video data from the camera in real-time. In another example, the risk estimation device 1B may store the video data from the camera 51 on a memory referrable by the risk estimation device 1B and perform the risk estimation using stored video data at a time at a predetermined timing. It is noted that the details of the risk estimation in the third example embodiment are according to the processes in the object detection unit 14, the scene graph generation unit 15, the inter-element relationship estimation unit 16, and the risk estimation unit 17.

Upon detecting a risk having a confidence level equal to or larger than a predetermined threshold value, the risk estimation device 1B output an alert or warning for notifying the hospital staff of the occurrence of the risk. The risk estimation device 1B may function as the risk estimation device 1 according to the first example embodiment, or may function as the risk estimation device 1A according to the second example embodiment. In a case where the risk estimation device 1B functions as the risk estimation device 1 according to the first example embodiment, the risk estimation device 1B is connected to or incorporates the input device 2, the output device 3, and the storage device 4 and causes the output device 3 to output a warning upon detecting a risk. In a case where the risk estimation device 1B functions as the risk estimation device 1A according to the second example embodiment, the risk estimation device 1B is situated outside the hospital and causes the terminal device 8 usable by the hospital staff in the hospital to output a warning upon detecting a risk.

The risk estimation device 1B may output a warning only to the hospital staff or specific person or may output a warning to unspecified people through announcement in the hospital by controlling an announcement equipment in the hospital.

Instead of outputting a warming upon detection of a risk, the risk estimation device 1B may make a report indicating the detected risk and output the report at a predetermined timing. In this case, the risk estimation device 1B may transmit the report indicating the detected risk to another device or may store it on its memory. For example, the risk estimation device 1B makes a message indicating the detected risk for a target person and deliver the message to a terminal owned by the target person. The process related to the output of such a warning or report corresponds to the process executed by the output control unit 18 in the first example embodiment.

Examples of classes of the “person” in this example embodiment include “patient”, “medical staff”, and “visitor”. Examples of classes of the “physical object” in this example embodiment include “medical apparatus”, “instillator”, “wagon”, and “wheelchair”. Examples of classes of the “risk” in this example include “situation where a patient is about to touch a medical apparatus”, “situation where a patient with instillator and a visitor with a wheelchair are about to collide with each other”, and “situation where a person with a cane and a patient with instillator are about to collide with each other”.

In some embodiments, the risk estimation device 1B may perform a risk estimation based on the video data from the camera 51 in real-time, and output a warning regarding the detected risk. In some embodiments, the video data from the camera 51 is stored in the memory and the risk estimation device 1B may perform the risk estimation based on the stored video data at a time to output the report thereof.

A description will be given of the flow after warning the detected risk. With reference to the information output as the warning by the risk estimation device 1, the hospital staff, which has received the warning regarding the occurrence of the risk, confirms the detected risk and the abnormality which causes the risk and conducts a proper countermeasure. Examples of the countermeasure include “rush to the scene of the abnormality”, “provide a patient with a proper care”, and “re-arrange medical equipment”.

In some embodiments, the risk estimation device 1B may determine the countermeasure in accordance with the detected risk to notify the hospital staff of the determined countermeasure. In this case, for example, the risk estimation device 1B determine the countermeasure to be conducted in accordance with estimated content and degree of the risk, using rule information indicative of the correspondence between a possible combination of the content and degree of the risk and the countermeasure to be determined against the risk. The “content and degree of the risk” is, for example, equivalent to the class and confidence level of the risk indicated by the risk estimation result. The rule information is stored in advance in the memory referable by the risk estimation device 1B.

In some embodiments, instead of using the rule information, the risk estimation device 1B may determine the countermeasure using a machine learning model which has learned the relationship between the content and degree of the risk and the countermeasure to be conducted. In this case, the machine learning model is a model trained to output the countermeasure to be conducted upon taking, as input, data indicating the content and degree of the risk. The machine learning model is a machine learning model (including any statistic model, the same is true hereinafter) having an architecture such as a neural network or support vector machine. The parameters of the trained machine learning model is stored in advance in a memory referable by the risk estimation device 1B.

In some embodiments, the video data from the camera 51 acquired by the video monitoring system 100B is transmitted from the camera 51 or the risk estimation device 1B to an unshown server device and the server device accumulates the video data and analyzes the accumulated video data as necessary. Such analysis can contribute to the development of more efficient algorithm (including a machine learning model) on the risk estimation and the prediction of the occurrence of the risk.

A description will be given of the effect according to the third example embodiment. The detection of the risk such as abnormal actions using image recognition technology according to the third example embodiment allows for earlier detection of the abnormality which causes the risk than the conventional manual monitoring, which can prevent accidents and troubles. Thereby, it is possible to ensure the safety of patients in the hospital while reducing the burden of the hospital staff.

The video monitoring system 100B according to the third example embodiment can optimize the action of the hospital staff by presenting the countermeasure to the hospital staff upon detecting the occurrence of the risk. Besides, the video monitoring system 100B can assist the hospital worker to conduct a decision making by presenting such a countermeasure to the hospital worker.

The vide monitoring system 100B according to the third example embodiment stores and analyzes the video data generated by the camera 51, which contributes to the development of more efficient algorithm on the risk estimation and the prediction of the occurrence of the risk.

### Fourth Example Embodiment

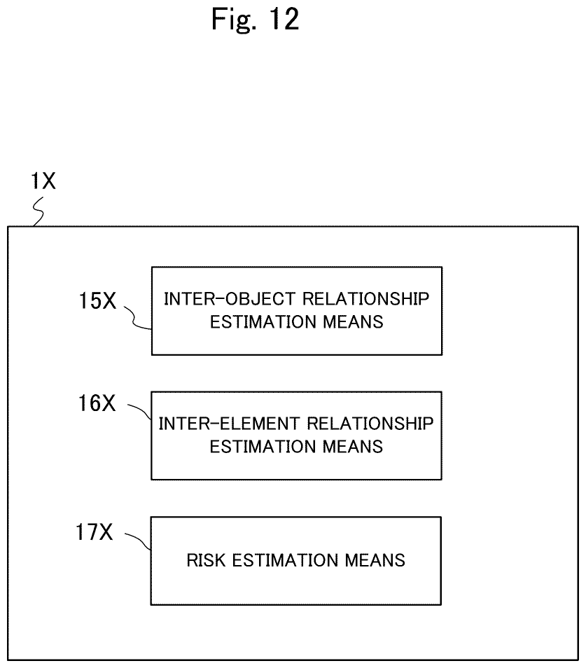

FIG. 12 is a block diagram of the risk estimation device 1X according to the fourth example embodiment. The risk estimation device 1X mainly includes an inter-object relationship estimation means 15X, an inter-element relationship estimation means 16X, and a risk estimation means 17X. The risk estimation device 1X may be configured by plural devices.

The inter-object relationship estimation means 15X is configured to estimate a relationship between objects detected based on observation data. Examples of the inter-object relationship estimation means 15X include the scene graph generation unit 15 according to any one of the first to third example embodiments.

The inter-element relationship estimation means 16X is configured to estimate a relationship between elements in a case where the relationship between the objects and the objects having the relationship are used as the elements. Examples of the inter-element relationship estimation means 16X include the inter-element relationship estimation unit 16 according to any one of the first to third example embodiments.

The risk estimation means 17X is configured to estimate, based on the elements and the relationship between the elements, a risk in a space observed based on the observation data. Examples of the risk estimation means 17X include the risk estimation unit 17 according to any one of the first to the third example embodiments.

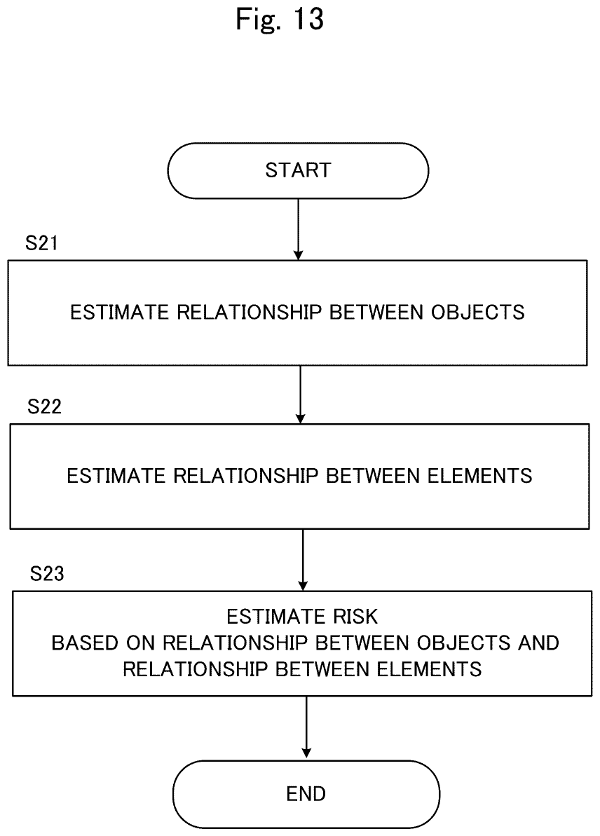

FIG. 13 illustrates a flowchart executed by the risk estimation device 1X according to the fourth example embodiment. First, the inter-object relationship estimation means 15X estimates a relationship between objects detected based on observation data (step S21). Then, the inter-element relationship estimation means 16X estimates a relationship between elements in a case where the relationship between the objects and the objects having the relationship are used as the elements (step S22). The risk estimation means 17X estimates, based on the elements and the relationship between the elements, a risk in a space observed based on the observation data (step S23).

The risk estimation device 1X according to the fourth example embodiment can accurately estimate the risk in the space identified by the observation data.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above (including modifications, the same applies hereinafter) can be described as, but not limited to, the following Supplementary Notes.
[Supplementary Note 1]

A risk estimation device comprising:
an inter-object relationship estimation means for estimating a relationship between objects detected based on observation data;
an inter-element relationship estimation means for estimating a relationship between elements in a case where the relationship between the objects and the objects having the relationship are used as the elements; and
a risk estimation means for estimating, based on the elements and the relationship between the elements, a risk in a space observed based on the observation data.
[Supplementary Note 2]

The risk estimation device according to Supplementary Note 1, wherein the inter-object relationship estimation means generates a scene graph indicating the relationship between the objects, and
the risk estimation means estimates the risk based on the scene graph and the relationship between the elements.
[Supplementary Note 3]

The risk estimation device according to Supplementary Note 1, wherein the inter-element relationship estimation means estimates a relationship related to a distance between the elements as the relationship between the elements.
[Supplementary Note 4]

The risk estimation device according to Supplementary Note 1, wherein the inter-object relationship estimation means estimates a relationship between a person included in the object and a physical object other than the person included in the object as the relationship between the objects.
[Supplementary Note 5]

The risk estimation device according to Supplementary Note 4, wherein the inter-element relationship estimation means estimates, as the relationship between the elements, whether or not the elements indicate the person in common.
[Supplementary Note 6]

The risk estimation device according to Supplementary Note 1, further comprising a prediction means for predicting states of the objects,
wherein the risk estimation means estimates the risk based on the elements determined based on the predicted states and a predicted relationship between the elements.
[Supplementary Note 7]

The risk estimation device according to Supplementary Note 1, wherein the risk estimation means estimates the risk based on the elements and the relationship between the elements and a machine learning model, and
the machine learning model is a model trained to output an estimation result for the risk upon taking, as input, data indicating the elements and the relationship between the elements.
[Supplementary Note 8]

The risk estimation device according to Supplementary Note 1, further comprising
an output control means for outputting, based on the estimated risk, at least one of information regarding occurrence of the risk or a countermeasure for addressing the risk.
[Supplementary Note 9]

The risk estimation device according to Supplementary Note 8, wherein the space is a medical workplace,
the countermeasure is a countermeasure for optimizing an action of a medical worker engaged in the medical workplace, and
the output control means outputs a notification of the countermeasure to the medical worker.
[Supplementary Note 10]

The risk estimation device according to Supplementary Note 8, wherein the output control means determines the countermeasure based on the estimated risk and a machine learning model, and
the machine learning model is a model that is trained on a relationship between the estimated risk and the countermeasure.
[Supplementary Note 11]

A risk estimation method by a computer, comprising:
estimating a relationship between objects detected based on observation data;
estimating a relationship between elements in a case where the relationship between the objects and the objects having the relationship are used as the elements; and
estimating, based on the elements and the relationship between the elements, a risk in a space observed based on the observation data.
[Supplementary Note 12]

A storage medium storing a program for causing a computer to execute processing comprising:
estimating a relationship between objects detected based on observation data;
estimating a relationship between elements in a case where the relationship between the objects and the objects having the relationship are used as the elements; and
estimating, based on the elements and the relationship between the elements, a risk in a space observed based on the observation data.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A, 1B, 1X Risk estimation device
2 Input device
3 Output device
4 Storage device
5 Observation device
8 Terminal device
11 Processor
12 Memory
13 Interface
51 Camera
90 Data bus
99 Network
100, 100A Risk estimation system
100B Video monitoring system

What is claimed is:

1. A risk estimation device comprising:
at least one memory configured to store instructions; and
at least one processor configured to execute the instructions to:
estimate a relationship between objects detected based on observation data;
estimate a relationship between elements in a case where the relationship between the objects and the objects having the relationship are used as the elements; and
estimate, based on the elements and the relationship between the elements, a risk in a space observed based on the observation data.

2. The risk estimation device according to claim 1, wherein the at least one processor is configured to execute the instructions to generate a scene graph indicating the relationship between the objects, and
the at least one processor is configured to execute the instructions to estimate the risk based on the scene graph and the relationship between the elements.

3. The risk estimation device according to claim 1, wherein the at least one processor is configured to execute the instructions to estimate a relationship related to a distance between the elements as the relationship between the elements.

4. The risk estimation device according to claim 1, wherein the at least one processor is configured to execute the instructions to estimate a relationship between a person included in the object and a physical object other than the person included in the object as the relationship between the objects.

5. The risk estimation device according to claim 4, wherein the at least one processor is configured to execute the instructions to estimate, as the relationship between the elements, whether or not the elements indicate the person in common.

6. The risk estimation device according to claim 1,
wherein the at least one processor is configured to execute the instructions to predict states of the objects, and
wherein the at least one processor is configured to execute the instructions to estimate the risk based on the elements determined based on the predicted states and a predicted relationship between the elements.

7. The risk estimation device according to claim 1, wherein the at least one processor is configured to execute the instructions to estimate the risk based on the elements and the relationship between the elements and a machine learning model, and
the machine learning model is a model trained to output an estimation result for the risk upon taking, as input, data indicating the elements and the relationship between the elements.

8. The risk estimation device according to claim 1,
wherein the at least one processor is configured to execute the instructions to output, based on the estimated risk, at least one of information regarding occurrence of the risk or a countermeasure for addressing the risk.

9. The risk estimation device according to claim 8, wherein the space is a medical workplace, and
the at least one processor is configured to execute the instructions to output a notification of the countermeasure to a medical worker engaged in the medical workplace to assist the medical worker to conduct a decision making.

10. The risk estimation device according to claim 8, wherein the at least one processor is configured to execute the instructions to determine the countermeasure based on the estimated risk and a machine learning model, and
the machine learning model is a model that is trained on a relationship between the estimated risk and the countermeasure.

11. A risk estimation method by a computer, comprising:
estimating a relationship between objects detected based on observation data;
estimating a relationship between elements in a case where the relationship between the objects and the objects having the relationship are used as the elements; and
estimating, based on the elements and the relationship between the elements, a risk in a space observed based on the observation data.

12. A non-transitory computer readable storage medium storing a program for causing a computer to execute processing comprising:
estimating a relationship between objects detected based on observation data;
estimating a relationship between elements in a case where the relationship between the objects and the objects having the relationship are used as the elements; and
estimating, based on the elements and the relationship between the elements, a risk in a space observed based on the observation data.
